(19) United States
(12) Patent Application Publication
(10) Pub. No.: US 2007/0139009 A1
(43) Pub. Date: Jun. 21, 2007

(54) Battery charge circuit with multi-charge stage and method thereof

(76) Inventor: Sheng-Chan Lin, Taipei City (TW)

Correspondence Address: RABIN & Berdo, PC, 1101 14TH STREET, NW, SUITE 500, WASHINGTON, DC, 20005, US

(21) Appl. No.: 11/304,750

(22) Filed: Dec. 16, 2005

(51) Int. Cl. H02J 7/00

(52) U.S. Cl. 320/125

(57) ABSTRACT

A charge method for charging a battery is provided. The method involves, in a first charge stage, applying a first charge power having a first charge current in pulse form with a first frequency and a first charge voltage to charge the battery; in a second charge stage following the first charge stage, applying a second power having a second charge current in pulse form with the first frequency and a second charge voltage to charge the battery; in a third charge stage following the second charge stage, applying a third charge power having a third charge current in pulse form with the first frequency and a third charge voltage to charge the battery; in a fourth charge stage following the third charge stage, applying a fourth charge power having a fourth charge current in pulse form with the first frequency and a fourth charge voltage to charge the battery.

### BACKGROUND

1. Field of the Invention

The invention relates to a charge circuit/method and in particular to a charge circuit/method using charge current and voltage in pulses to charge batteries.

2. Related Art

Batteries of all shapes and sizes, available in sealed and maintenance-free products, are mass-produced today. Batteries are commonly used to provide a direct-current (dc) source of electrical energy in a wide variety of applications.

Battery charging is accomplished through delivery of an external power source to a battery, thereby ionizing the plates to opposing potentials (voltages or electrical pressures) and reversing the electrochemical process that occurs when the battery is used to supply energy to a load. Refer to FIG. 1 depicting a charge topology of half constant current. The voltage in the battery increases with time, while the charge current decreases gradually. Refer to FIG. 2 depicting a charge topology of constant current. In FIG. 2, the charge current remains constant during the whole charge.

Refer to FIG. 3 depicting a charge topology of constant current and current voltage. The topology in FIG. 3 is a multi-stage charge method, which may reduce the charge time. A multi-stage charger first applies a constant current charge, raising the cell voltage to a preset voltage. The battery is charged to such as 70% in stage 1. During the topping charge in stage 2 that follows, the charge current is gradually reduced as the cell is being saturated.

The charge method illustrated in FIG. 1˜3 may not fully charge the energy into the batteries. Further, the constant charge current in the conventional charge method is difficult to deliver into the battery continuously. For other batteries, like silicone power battery, the internal resistance of these batteries increases with the usage. Thus, charge energy into the batteries becomes more and more difficult. Besides, the ageing of batteries also arise difficulty of charge.

For some large capacity batteries, charge and discharge of the power source to and from batteries is done by chemical reaction. Some production is generated during the chemical reaction process. In these batteries, lead-acid batteries may be assembled to provide the greatest energy density, and have the longest life cycle. In lead acid batteries, the reaction of lead and lead oxide with the sulfuric acid electrolyte produces a voltage. The supplying of energy to and external resistance discharges the battery. Lead Sulfate is generated in the charge and discharge process for lead acid batteries. Lead Sulfate not only results in unfull charge of the batteries, but also decrease of life-span.

### SUMMARY

Accordingly, a battery charge circuit and method thereof are provided. Features and advantages of the provided battery charge circuit and method thereof will be set forth in the description which follows, and in part will be apparent from the description, or may be learned by practice of the invention. The objectives and other advantages of the invention will be realized and attained by the method and apparatus particularly pointed out in the written description and claims of the present application, as well as the appended drawings.

As embodied and broadly described, a multi charge stage is employed in the charge method which involves with: in a first charge stage, applying a first charge power having a first charge current in pulse form with a first frequency and a first charge voltage to charge the at least one battery, wherein the first charge current in the first charge stage remains substantially constant, the first charge voltage remains a fist constant voltage; in a second charge stage following the first charge stage, applying a second power having a second charge current in pulse form with the first frequency and a second charge voltage to charge the at least one battery, wherein the second charge current in the second charge stage decreases gradually, the charge voltage remains the fist constant voltage; in a third charge stage following the second charge stage, applying a third charge power having a third charge current in pulse form with the first frequency and a third charge voltage to charge the at least one battery, wherein the third current in the third charge stage decreases gradually, the third charge voltage remains a second constant voltage is higher than the first constant voltage in the second charge stage; and in a fourth charge stage following the third charge stage, applying a fourth charge power having a fourth charge current in pulse form with the first frequency and a fourth charge voltage to charge the at least one battery, wherein the fourth current in the fourth charge stage decreases gradually, the fourth charge voltage remains a second constant voltage is higher than the first constant voltage in the second charge stage.

As embodied and broadly described, a multi charge stage is employed in the charge method which involves with: in a first charge stage, applying a first charge power having a first charge current in pulse form with a first frequency and a first charge voltage to charge the at least one battery, wherein the first charge current in the first charge stage remains substantially constant, the first charge voltage remains a fist constant voltage; in a second charge stage following the first charge stage, applying a second power having a second charge current in pulse form with the first frequency and a second charge voltage to charge the at least one battery, wherein the second charge current in the second charge stage decreases gradually, the charge voltage remains the fist constant voltage; in a third charge stage following the second charge stage, applying a third charge power having a third charge current in pulse form with the first frequency and a third charge voltage to charge the at least one battery, wherein the third current in the third charge stage decreases gradually, the third charge voltage remains a second constant voltage is higher than the first constant voltage in the second charge stage; in a fourth charge stage following the third charge stage, applying a fourth charge power having a fourth charge current in pulse form with the first frequency and a fourth charge voltage to charge the at least one battery, wherein the fourth current in the fourth charge stage decreases gradually, the fourth charge voltage remains a second constant voltage is higher than the first constant voltage in the second charge stage; and in a maintenance stage following the fourth charge stage, applying a fifth current maintain the battery until the battery is substantially full charged.

In other aspect, the charge method which involves with: in a first charge stage, applying a first charge power having a first charge current with a first frequency and a first charge voltage to charge the at least one battery, wherein the first charge current in the first charge stage remains substantially constant, the first charge voltage remains a fist constant voltage; in a second charge stage following the first charge stage, applying a second power having a second charge current with the first frequency and a second charge voltage to charge the at least one battery, wherein the second charge current in the second charge stage decreases gradually, the charge voltage remains the fist constant voltage; after the second charge stage, applying a variant current with a second frequency, wherein the charge voltage in this stage varies with the second frequency; in a third charge stage following the second charge stage, applying a third charge power having a third charge current with the first frequency and a third charge voltage to charge the at least one battery, wherein the third current in the third charge stage decreases gradually, the third charge voltage remains a second constant voltage is higher than the first constant voltage in the second charge stage; and in a fourth charge stage following the third charge stage, applying a fourth charge power having a fourth charge current with the first frequency and a fourth charge voltage to charge the at least one battery, wherein the fourth current in the fourth charge stage decreases gradually, the fourth charge voltage remains a second constant voltage is higher than the first constant voltage in the second charge stage.

In other aspect, the charge method which involves with: in a first charge stage, applying a first charge power having a first charge current with a first frequency and a first charge voltage to charge the at least one battery, wherein the first charge current in the first charge stage remains substantially constant, the first charge voltage remains a fist constant voltage; in a second charge stage following the first charge stage, applying a second power having a second charge current with the first frequency and a second charge voltage to charge the at least one battery, wherein the second charge current in the second charge stage decreases gradually, the charge voltage remains the fist constant voltage; in a third charge stage following the second charge stage, applying a third charge power having a third charge current with the first frequency and a third charge voltage to charge the at least one battery, wherein the third current in the third charge stage decreases gradually, the third charge voltage remains a second constant voltage is higher than the first constant voltage in the second charge stage; in a fourth charge stage following the third charge stage, applying a fourth charge power having a fourth charge current with the first frequency and a fourth charge voltage to charge the at least one battery, wherein the fourth current in the fourth charge stage decreases gradually, the fourth charge voltage remains a second constant voltage is higher than the first constant voltage in the second charge stage; and in a maintenance stage following the fourth charge stage, applying a fifth current maintain the battery until the battery is substantially full charged.

According to the embodiments, using pulses to charge batteries may reduce generation of the lead sulfate during the charge. Therefore, batteries may have full charge and the life-span increases.

According to the embodiments, the charge current in pulse form may be applied to the batteries for maintenance after charging batteries. The low temperature causes batteries capacity to decrease in cool or cold region. The pulses provided after charging prevents the capacity decrease. Therefore, extra apparatuses or electrical maintenance devices for maintenance after charge is not necessary.

According to the embodiments, there are multi charge stages. The stage is adjustable according the charge state of the batteries. The charge efficiency is improved and time saving.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

### BRIEF DESCRIPTION OF THE DRAWINGS

The above and other objects, features and other advantages of the invention will be more clearly understood from the following detailed description when taken in conjunction with the accompanying drawings, in which:

FIG. 1 illustrates a charge topology of the prior art.

FIG. 2 illustrates another charge topology of the prior art.

FIG. 3 illustrates another charge topology of the prior art.

FIG. 4 illustrates an embodiment in accordance with the charge topology of the invention.

FIG. 5 illustrates another embodiment in accordance with the charge topology of the invention.

FIG. 6 illustrates another embodiment in accordance with the charge topology of the invention.

FIG. 7 illustrates another embodiment in accordance with the charge topology of the invention.

FIG. 8 illustrates another embodiment in accordance with the charge topology of the invention.

FIG. 9 illustrates another embodiment in accordance with the charge topology of the invention.

FIG. 10 illustrates an embodiment of a charge circuitry in accordance with the charge topology of the invention.

FIG. 11 illustrates another embodiment of a charge circuitry in accordance with the charge topology of the invention.

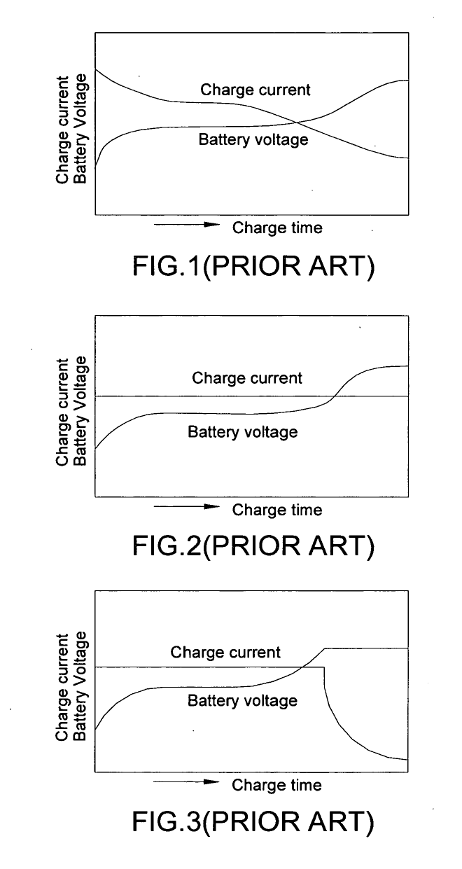

### DETAILED DESCRIPTION

Reference will now be made in greater detail to an embodiment of the invention, an example of which is illustrated in the accompanying drawings. Wherever possible, the same reference numerals are used throughout the drawings and the description to refer to the same or like parts.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

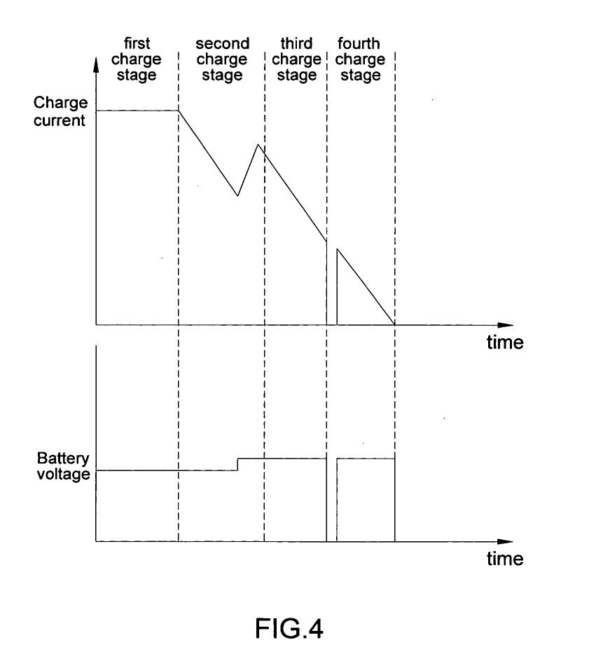

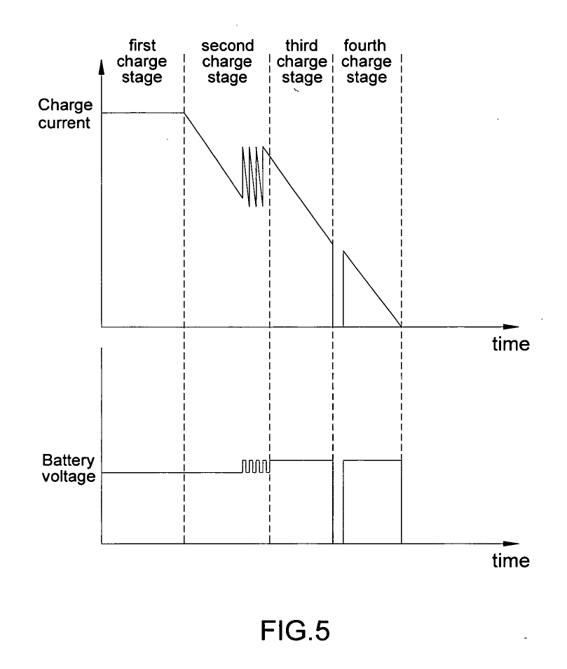

FIG. 4 illustrates a charge topology of the invention. In FIG. 4, a multi charge stage charge topology is employed. The main charge stages are the first charge stage, the second charge stage, the third charge stage, and the fourth charge stage respectively. In the embodiment, in the first charge stage, constant current mode is employed. In the following charge stages after the first charge stage, constant voltage mode is employed.

In the first charge stage, a first charge power having a first charge current in pulse form with a first frequency, for example 100 Hz to 120 Hz, and a first charge voltage is applied to charge the at least one battery. The first charge current in the first charge stage remains substantially constant; the first charge voltage remains a fist constant voltage CV1. Accordingly, the first charge stage is constant current mode. For per batter cell, the fist constant voltage CV1 may be 2.25 to 2.36 volts.

In the second charge stage following the first charge stage, a second power having a second charge current in pulse form with the first frequency and a second charge voltage is applied to charge the at least one battery. The second charge current in the second charge stage decreases gradually. The second charge voltage remains the fist constant voltage CV1. As illustrated in the figure, the starting current of the second charge current in the second charge stage is lower than the first charge current.

In the third charge stage following the second charge stage, a third charge power having a third charge current in pulse form with the first frequency and a third charge voltage to charge the at least one battery. The third current in the third charge stage decreases gradually, the third charge voltage remains a second constant voltage CV2 is higher than the first constant voltage CV1 in the second charge stage. The starting current of the third charge current is higher than the ending current of the second charge stage and lower than the first charge current. For per batter cell, the second constant voltage CV2 may be 2.41 to 2.5 volts.

In the fourth charge stage following the third charge stage, a fourth charge power having a fourth charge current in pulse form with the first frequency and a fourth charge voltage is applied to charge the at least one battery. The fourth current in the fourth charge stage decreases gradually, the fourth charge voltage remains a second constant voltage CV2 is higher than the first constant voltage CV1 in the second charge stage.

In the above mentioned embodiments, the charge current is the chare stages are pulse form. For Lead Acid batteries, in the first to fourth charge stage, the charge current applied in pulse form may reduce the generation of Lead Sulfate on the electrodes of batteries, and the energy is easy to charge into the battery. For some other batteries, like silicone power battery, the charge current applied in pulse form may reduce the internal resistance of these batteries, and the energy is easy to charge into the battery.

Alternatively, a variant current in pulse form with a second frequency between the second charge stage and the third charge stage is optionally applied, as illustrated in FIG. 5. The second frequency may optionally be 10 Hz˜20 Hz. The charge voltage in this stage varies with the second frequency. The variant current may prevent damage of the battery during charge and reduce charge time. The second frequency is smaller than the first frequency.

Alternatively, a step of suspending charge of the at least one battery for a predetermined time, such as 45 seconds, is employed between the third charge stage and the fourth charge stage, as illustrated in FIG. 4 and FIG. 5. The virtual potential of the battery may be detected by suspending charge. In the circuitry, it may be detected by a dummy load, such as fan.

Alternatively, after the battery is very close to full charge, a maintenance stage following the fourth charge stage is continued, as illustrated in FIG. 4 and FIG. 5. In the maintenance stage, a fifth current is applied to maintain the battery until the battery is substantially full charged.

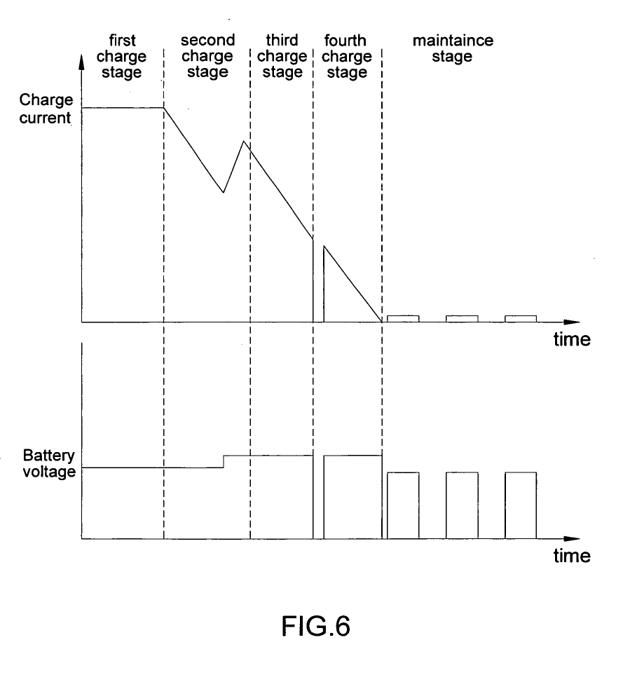

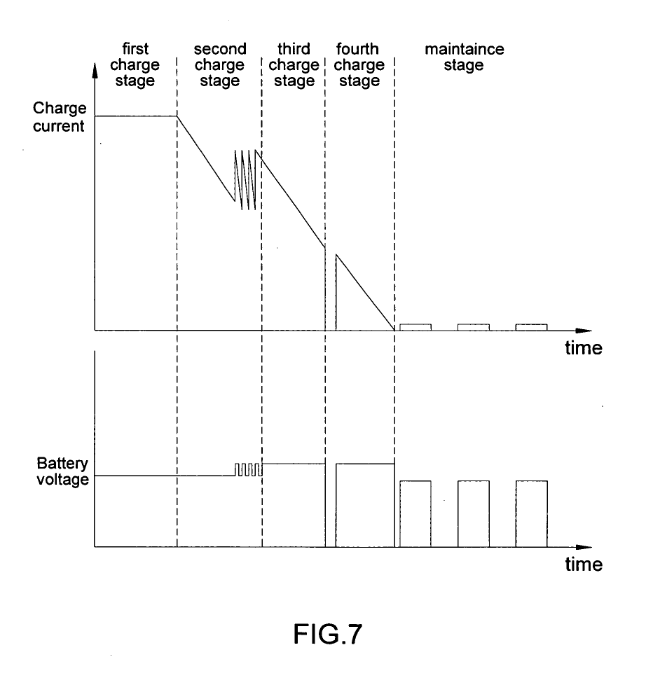

Alternatively, in the maintenance stage, as illustrated in FIG. 6 and FIG. 7, when the battery voltage of the battery is lower than a predetermined voltage, the fifth current is applied again to the battery for remaintain the at least one battery.

Alternatively, in the maintenance stage, when the battery voltage of the battery is lower than a predetermined voltage, a sixth current which is different from the fifth current is applied to recharge the at least one battery.

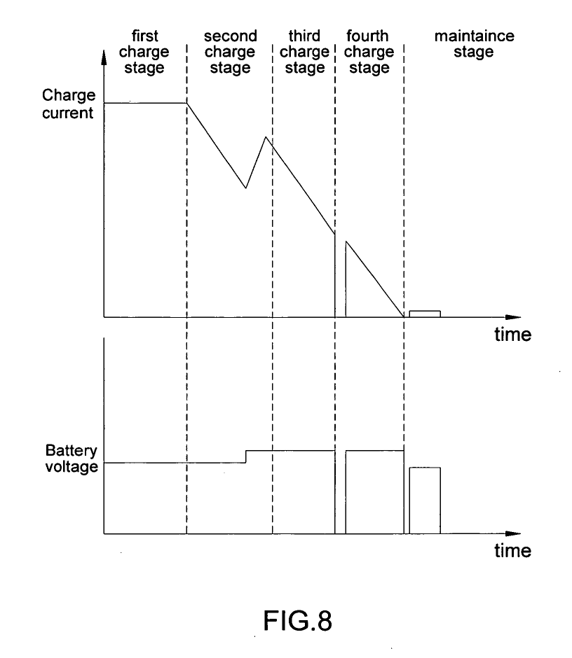

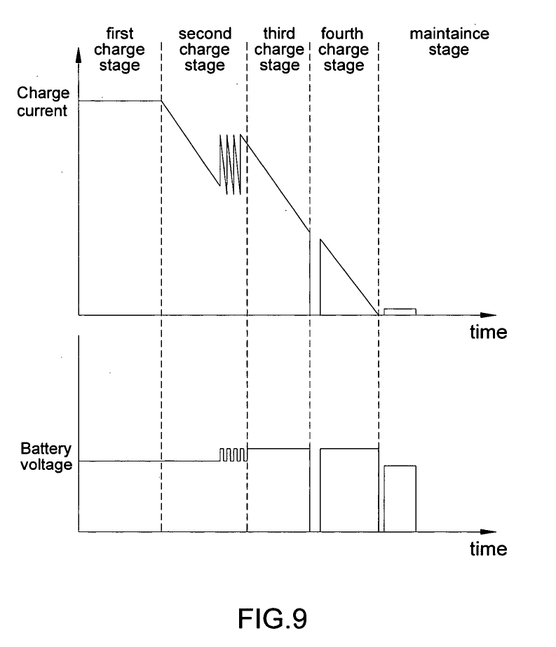

Alternatively, in the maintenance stage, as illustrated in FIG. 8 and FIG. 9, when the battery voltage of the battery is lower than a predetermined voltage, the fifth current is applied again to the battery for remaintain the at least one battery. In this embodiment, the fifth current is applied for one time.

Also in this embodiment as illustrated in FIG. 8 and FIG. 9, in the maintenance stage, when the battery voltage of the battery is lower than a predetermined voltage, a sixth current which is different from the fifth current is applied to recharge the at least one battery.

As illustrated in previous figures, the battery voltage is lower than the second voltage CV2. Alternatively, the battery voltage is the same as the second voltage CV2.

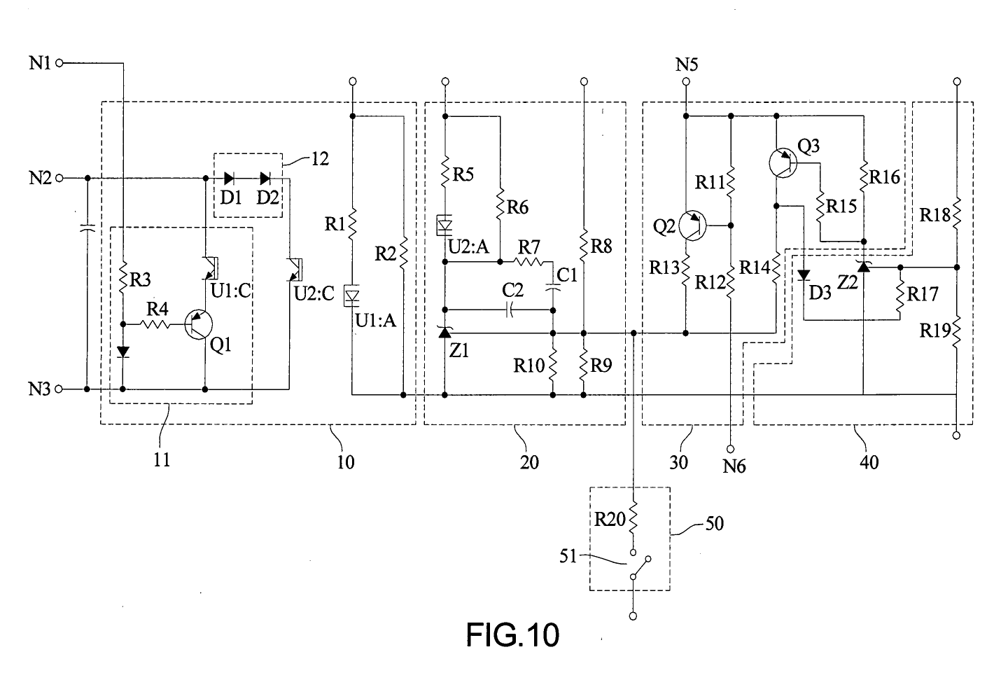

FIG. 10 illustrates an embodiment of a circuitry in accordance with the charge topology of the invention. The charge circuit in FIG. 6 includes a first current generating circuit 10, a control circuit 20 for controlling a microprocessor, a voltage generating circuit 30 for generating a constant voltage, and a second current generating circuit 40. In this circuit, the integrated circuit (IC) is arranged at the primary side of the transformer, therefore, separated element are necessary in this circuit.

According to the charge topology of the embodiments, In the first charge stage, a first charge power having a first charge current in pulse form with a first frequency, for example and a first charge voltage is applied to charge the at least one battery. The first current generating circuit 10 generates a first charge current in pulse form with a first frequency. The first frequency, for example, may be 100 Hz to 120 Hz. The first current generating circuit 10 is connected to and controlled by a microprocessor (not shown) such that the first charge current is generated in pulse form with the first frequency.

In one embodiment, a first resistor R1 and a first photodiode U1 is included in the first pulse generating circuit 10. An additional resistor R2 may be optionally connected with the first resistor R1 and the first photodiode U1 in parallel.

In one embodiment, when the battery voltage is higher than the voltage provided by the charging circuit, a control circuit 11 is provided to supply a small power source to the microprocessor to prevent shut down of the microprocessor. Two resistors R3, R4 connected in series are provided in the control circuit 11. One terminal of the resistor R3 is connected to a first node N1 for receiving a reference voltage. The base of the first transistor Q1 is connected to the resistor R4. The emitter of the first transistor Q1 is connected to the third terminal of the first photodiode U1, while the collector of the first transistor Q1 is connected to a third node N3. The second node N2 and the third node N3 may connect to an integrated circuit. A pulse provider 12 with minimum duty is provided to the control circuit 12 by having two diodes D1, D2 connected in series. A second photodiode U1 is also provided in the first pulse generating circuit 10. The fourth terminal of the second photodiode U1 is connected to the diode D2, while the third terminal of the second photodiode U1 is connected to the second node N3 (and the collector of the first transistor Q1).

The first current generating circuit 10 generates the first charge current in pulse form with the first frequency in the first charge stage. In this stage, the first charge current in the first charge stage remains substantially constant; the first charge voltage remains a fist constant voltage. Therefore, the first charge current in pulse form remains substantially constant. The first charge voltage is controlled by a voltage generating circuit 20.

In the voltage generating circuit 20, the third terminal of the second photodiode U2 is connected to the resistor R5. The resistors R6, R7 and the capacitors C1, C2 are connected in series for feedback compensation. The resistors R8, R9 connected in series and a Zener diode Z1 are employed for feedback voltage control. The resistor R10 connected in parallel with the resistor R9 is optionally provided to fine tuning the provided current and voltage.

As previously mentioned, in the second charge stage, the charge voltage remains the fist constant voltage CV1. In the third charge stage, the third charge voltage remains a second constant voltage CV2 is higher than the first constant voltage CV1 in the second charge stage. In the fourth charge stage, the fourth charge voltage remains a second constant voltage CV2 is higher than the first constant voltage CV1 in the second charge stage. The first constant voltage CV1 and the second constant voltage CV2 are controlled by a voltage control circuit 30.

The fifth node N5 receives the battery voltage. The first constant voltage CV1 and the second constant voltage CV2 are delivered from the sixth node N6. The emitter of the second transistor Q2 is connected to the fifth node N5. The resistors R11, R12 are connected in series. The resistor R13 is connected to the collector of the second transistor Q2. The resistor R14 is connected to the third transistor Q3; the resistor R15 is connected to the base of the second transistor Q2; the resistor R16 is connected to the emitter of the second transistor Q2. When the third transistor Q3 turns on, the first constant voltage CV1 is delivered from the sixth node N6; when the third transistor Q3 turns off, the second constant voltage CV2 is delivered from the sixth node N6.

In a maintenance stage following the fourth charge stage, a fifth current is applied to maintain the battery until the battery is substantially full charged. A fifth voltage corresponding to the fifth current is also generated in the maintenance stage. The fifth voltage, or maintenance voltage is controlled by the voltage control circuit 30. When the third transistor Q3 turns off and the second transistor Q2 turns on, the maintenance voltage is delivered from the sixth node N6.

For prevention damage of the battery during charge and reduction of charge time, a variant current in pulse form with a second frequency between the second charge stage and the third charge stage is optionally applied. The charge voltage in this stage varies with the second frequency. The second frequency is controlled by a second current generating circuit 40. A second Zener diode Z2 is connected to the resistor R16. The resistor R17 is connected with the diode D3 in series. The resistors R18, R19 are connected in series. Through the operation of the diode D3, the resistor R14 and the second Zener diode Z2, the second frequency is thereby delivered.

A detecting circuit 50 having a resistor R20 and a switch 51, such as the diode or transistor, connected in series is alternatively provided. When the switch 51 is on, the circuit is directed to the ground. When the switch is off, the circuit is directed to float. The charge voltage in the battery may be detected through the resistor R20 and the switch.

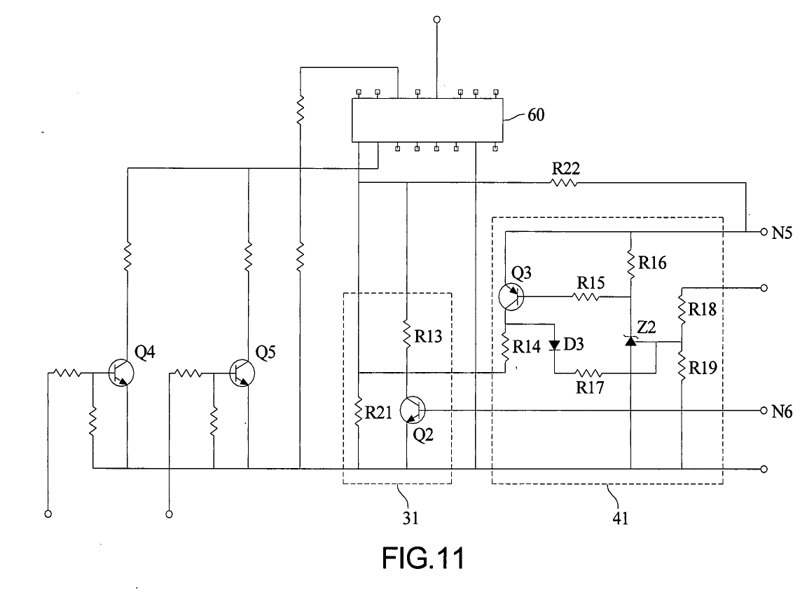

FIG. 11 illustrates another embodiment of a circuitry in accordance with the charge topology of the invention. The charge circuit in FIG. 11 includes a voltage generating circuit 31 for generating a constant voltage, and a second current generating circuit 41. In this circuit, the integrated circuit (IC) is arranged at the secondary side of the transformer, therefore, separated element are not necessary in this circuit.

The operation and function of the voltage generating circuit 31 is similar to the voltage generating circuit 30 in the previously mentioned embodiment. The operation and function of the second current generating circuit 41 is similar to the second current generating circuit 40 in the previously mentioned embodiment. The resistor R21, R22 connected in series which is not included in the previously mentioned embodiment is arranged in the voltage generating circuit 31.

In the second charge stage, the charge voltage remains the fist constant voltage. In the third charge stage, the third charge voltage remains a second constant voltage is higher than the first constant voltage in the second charge stage. In the fourth charge stage, the fourth charge voltage remains a second constant voltage is higher than the first constant voltage in the second charge stage. The first constant voltage and the second constant voltage are controlled by a voltage control circuit 31.

The fifth node N5 receives the battery voltage. The first constant voltage and the second constant voltage are delivered from the sixth node N6. The resistor R15 is connected to the base of the third transistor Q3. The resistor R16 is connected to the resistor R15. The resistor R14 is connected to the collector of the third transistor Q3. The collector of the transistor Q2 is connected to the fifth node N5 though the resistors R13, R22 connected in series. One terminal of the transistor R21 is connected to the collector of the transistor Q2, and the other one is connected to the emitter of the transistor Q2

When the third transistor Q3 turns on, the first constant voltage is delivered from the sixth node N6; when the third transistor Q3 turns off, the second constant voltage is delivered from the sixth node N6.

The second frequency is controlled by a second current generating circuit 41. A Zener diode M3 is connected to the resistor R16. The resistor R17 is connected with the diode D3 in series. The resistors R18,R19 are connected in series.

In a maintenance stage following the fourth charge stage, a fifth current is applied to maintain the battery until the battery is substantially full charged. A fifth voltage corresponding to the fifth current is also generated in the maintenance stage. The fifth voltage, or maintenance voltage is controlled by the voltage control circuit 31. When the third transistor Q3 turns off and the transistor Q2 turns on, the maintenance voltage is delivered from the sixth node N6.

The transistor Q4, the transistor Q5 and the additional resistors are employed for a voltage divider for the integrated circuit 60.

According to the embodiments, constant current mode and constant voltage mode are employed during the charge process of batteries. The output voltage employed to charge the batteries can be controlled precisely. Further if the energy stored in the batteries decreases to a predetermined level after full charge, the disclosed charge method and circuit may apply a current to maintain the batteries automatically such that the batteries may remain full charge.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A charge method for charging at least one battery, the method comprising steps of:
in a first charge stage, applying a first charge power having a first charge current in pulse form with a first frequency and a first charge voltage to charge the at least one battery, wherein the first charge current in the first charge stage remains substantially constant, the first charge voltage remains a fist constant voltage;
in a second charge stage following the first charge stage, applying a second power having a second charge current in pulse form with the first frequency and a second charge voltage to charge the at least one battery, wherein the second charge current in the second charge stage decreases gradually, the charge voltage remains the fist constant voltage; and
in a third charge stage following the second charge stage, applying a third charge power having a third charge current in pulse form with the first frequency and a third charge voltage to charge the at least one battery, wherein the third current in the third charge stage decreases gradually, the third charge voltage remains a second constant voltage is higher than the first constant voltage in the second charge stage; and
in a fourth charge stage following the third charge stage, applying a fourth charge power having a fourth charge current in pulse form with the first frequency and a fourth charge voltage to charge the at least one battery, wherein the fourth current in the fourth charge stage decreases gradually, the fourth charge voltage remains a second constant voltage is higher than the first constant voltage in the second charge stage.

2. The method of claim 1, further comprising a step of applying a variant current in pulse form with a second frequency between the second charge stage and the third charge stage, wherein the charge voltage in this stage varies with the second frequency.

3. The method of claim 2, wherein the second frequency is smaller than the first frequency.

4. The method of claim 1, wherein the starting current of the second charge current in the second charge stage is lower than the first charge current.

5. The method of claim 1, wherein the starting current of the third charge current is higher than the ending current of the second charge stage and lower than the first charge current.

6. The method of claim 1 further comprising a step of suspending charge of the at least one battery for a predetermined time between the third charge stage and the fourth charge stage.

7. A charge method for charging at least one battery, the method comprising steps of:
in a first charge stage, applying a first charge power having a first charge current in pulse form with a first frequency and a first charge voltage to charge the at least one battery, wherein the first charge current in the first charge stage remains substantially constant, the first charge voltage remains a fist constant voltage;
in a second charge stage following the first charge stage, applying a second power having a second charge current in pulse form with the first frequency and a second charge voltage to charge the at least one battery, wherein the second charge current in the second charge stage decreases gradually, the charge voltage remains the fist constant voltage; and
in a third charge stage following the second charge stage, applying a third charge power having a third charge current in pulse form with the first frequency and a third charge voltage to charge the at least one battery, wherein the third current in the third charge stage decreases gradually, the third charge voltage remains a second constant voltage is higher than the first constant voltage in the second charge stage;
in a fourth charge stage following the third charge stage, applying a fourth charge power having a fourth charge current in pulse form with the first frequency and a fourth charge voltage to charge the at least one battery, wherein the fourth current in the fourth charge stage decreases gradually, the fourth charge voltage remains a second constant voltage is higher than the first constant voltage in the second charge stage; and
in a maintenance stage following the fourth charge stage, applying a fifth current maintain the battery until the battery is substantially full charged.

8. The method of claim 7 further comprising a step of suspending charge of the at least one battery for a predetermined time between the fourth charge stage and the maintenance stage.

9. The method of claim 7, wherein in the maintenance stage, when the battery voltage of the battery is lower than a predetermined voltage, applying the fifth current to the battery for remaintain the at least one battery.

10. The method of claim 7, wherein in the maintenance stage, when the battery voltage of the battery is lower than a predetermined voltage, applying a sixth current which is different from the fifth current to recharge the at least one battery.

11. The method of claim 7, further comprising a step of applying a variant current in pulse form with a second frequency between the second charge stage and the third charge stage, wherein the charge voltage in this stage varies with the second frequency.

12. The method of claim 11, wherein the second frequency is smaller than the first frequency.

13. The method of claim 7, wherein the starting current of the second charge current in the second charge stage is lower than the first charge current.

14. The method of claim 7, wherein the starting current of the third charge current is higher than the ending current of the second charge stage and lower than the first charge current.

15. The method of claim 7 further comprising a step of suspending charge of the at least one battery for a predetermined time between the third charge stage and the fourth charge stage.

16. A charge method for charging at least one battery, the method comprising steps of:
in a first charge stage, applying a first charge power having a first charge current with a first frequency and a first charge voltage to charge the at least one battery, wherein the first charge current in the first charge stage remains substantially constant, the first charge voltage remains a fist constant voltage;
in a second charge stage following the first charge stage, applying a second power having a second charge current with the first frequency and a second charge voltage to charge the at least one battery, wherein the second charge current in the second charge stage decreases gradually, the charge voltage remains the fist constant voltage;
after the second charge stage, applying a variant current with a second frequency, wherein the charge voltage in this stage varies with the second frequency;
in a third charge stage following the second charge stage, applying a third charge power having a third charge current with the first frequency and a third charge voltage to charge the at least one battery, wherein the third current in the third charge stage decreases gradually, the third charge voltage remains a second constant voltage is higher than the first constant voltage in the second charge stage; and
in a fourth charge stage following the third charge stage, applying a fourth charge power having a fourth charge current with the first frequency and a fourth charge voltage to charge the at least one battery, wherein the fourth current in the fourth charge stage decreases gradually, the fourth charge voltage remains a second constant voltage is higher than the first constant voltage in the second charge stage.

17. The method of claim 16, wherein the second frequency is smaller than the first frequency.

18. The method of claim 16, wherein the starting current of the second charge current in the second charge stage is lower than the first charge current.

19. The method of claim 16, wherein the starting current of the third charge current is higher than the ending current of the second charge stage and lower than the first charge current.

20. The method of claim 16 further comprising a step of suspending charge of the at least one battery for a predetermined time between the third charge stage and the fourth charge stage.

21. A charge method for charging at least one battery, the method comprising steps of:
in a first charge stage, applying a first charge power having a first charge current with a first frequency and a first charge voltage to charge the at least one battery, wherein the first charge current in the first charge stage remains substantially constant, the first charge voltage remains a fist constant voltage; in a second charge stage following the first charge stage, applying a second power having a second charge current with the first frequency and a second charge voltage to charge the at least one battery, wherein the second charge current in the second charge stage decreases gradually, the charge voltage remains the fist constant voltage; and
in a third charge stage following the second charge stage, applying a third charge power having a third charge current with the first frequency and a third charge voltage to charge the at least one battery, wherein the third current in the third charge stage decreases gradually, the third charge voltage remains a second constant voltage is higher than the first constant voltage in the second charge stage;
in a fourth charge stage following the third charge stage, applying a fourth charge power having a fourth charge current with the first frequency and a fourth charge voltage to charge the at least one battery, wherein the fourth current in the fourth charge stage decreases gradually, the fourth charge voltage remains a second constant voltage is higher than the first constant voltage in the second charge stage; and
in a maintenance stage following the fourth charge stage, applying a fifth current maintain the battery until the battery is substantially full charged.

22. The method of claim 21 further comprising a step of suspending charge of the at least one battery for a predetermined time between the fourth charge stage and the maintenance stage.

23. The method of claim 21, wherein in the maintenance stage, when the battery voltage of the battery is lower than a predetermined voltage, applying the fifth current to the battery for remaintain the at least one battery.

24. The method of claim 21, wherein in the maintenance stage, when the battery voltage of the battery is lower than a predetermined voltage, applying the sixth current which is different from the fifth current to recharge the at least one battery.

25. The method of claim 21, further comprising a step of applying a variant current with a second frequency between the second charge stage and the third charge stage, wherein the charge voltage in this stage varies with the second frequency.

26. The method of claim 25, wherein the second frequency is smaller than the first frequency.

27. The method of claim 21, wherein the starting current of the second charge current in the second charge stage is lower than the first charge current.

28. The method of claim 21, wherein the starting current of the third charge current is higher than the ending current of the second charge stage and lower than the first charge current.

29. The method of claim 21 further comprising a step of suspending charge of the at least one battery for a predetermined time between the third charge stage and the fourth charge stage.
